(19) United States
(12) Patent Application Publication
(10) Pub. No.: US 2017/0264428 A1
(43) Pub. Date: Sep. 14, 2017

(54) DATA STORAGE SYSTEM WITH BLOCKCHAIN TECHNOLOGY

(71) Applicant: MANIFOLD TECHNOLOGY, INC., MENLO PARK, CA (US)

(72) Inventor: Robert Allan SEGER, II, San Jose, CA (US)

(73) Assignee: MANIFOLD TECHNOLOGY, INC., MENLO PARK, CA (US)

(21) Appl. No.: 15/419,055

(22) Filed: Jan. 30, 2017

Related U.S. Application Data
(60) Provisional application No. 62/305,472, filed on Mar. 8, 2016.

(51) Int. Cl. H04L 9/06; G06F 17/30; H04L 9/32

(52) U.S. Cl. CPC H04L 9/0637; H04L 9/32; G06F 17/30864

(57) ABSTRACT

A blockchain processor may receive data associated with an interaction with a populated data storage system. The blockchain processor may hash a first previously entered data block at a first row address; combine the received data, the hash of the first previously entered data block, and the first row address into a data block; and store the data block.

### CROSS REFERENCE TO RELATED APPLICATIONS

This application claims priority to U.S. Provisional Application Ser. No. 62/305,472, filed Mar. 8, 2016. The entirety of the above-listed application is incorporated herein by reference.

### BRIEF DESCRIPTION OF THE DRAWINGS

FIG. 1 is a data storage system according to an embodiment of the invention.

FIG. 2 is a data storage system storage process according to an embodiment of the invention.

FIG. 3 is a data storage system auditing process according to an embodiment of the invention.

FIG. 4 is a communications network data flow according to an embodiment of the invention.

FIG. 5 is a message storage and transmission process according to an embodiment of the invention.

FIG. 6 is a data storage system structure according to an embodiment of the invention.

FIG. 7 is a data storage system according to an embodiment of the invention.

FIG. 8 is a data storage network according to an embodiment of the invention.

FIG. 9 is a data storage network according to an embodiment of the invention.

FIG. 10 is a state cache according to an embodiment of the invention.

FIG. 11 is a data storage system logging process according to an embodiment of the invention.

FIG. 12 is a query mirroring process according to an embodiment of the invention.

FIG. 13 is a network logging process according to an embodiment of the invention.

FIG. 14 is a query interception process according to an embodiment of the invention.

### DETAILED DESCRIPTION OF SEVERAL EMBODIMENTS

Systems and methods described herein may apply blockchain storage techniques to a variety of data storage strategies. For example, blockchains may be used with SQL and non-SQL databases or other data storage systems, although the embodiments disclosed herein may be applicable to data stores generally. Blockchains may be formed in a data storage system as data is stored, such that each new data block includes information about the previous data block entered. Auditing the data storage system may verify whether each block has the correct information about the previous block (and thus the previous block has not been tampered with) or not. This may improve data storage system functionality by building in a passive tamper detection mechanism to the data storage system. Furthermore, this may solve a problem unique to data storage wherein many types of data tampering are not detectable in a straightforward manner, due to the volatile environment provided by open data access and/or sophisticated network security defeating mechanisms.

In some embodiments, blockchain-enhanced data storage systems may be provided by computers and/or processors executing computer program instructions. A computer may be any programmable machine or machines capable of performing arithmetic and/or logical operations. In some embodiments, computers may comprise processors, memories, data storage devices, and/or other commonly known or novel elements. These elements may be connected physically or through network or wireless links. Computers may also comprise software which may direct the operations of the aforementioned elements. Computers may be referred to with terms that are commonly used by those of ordinary skill in the relevant arts, such as servers, PCs, mobile devices, routers, switches, data centers, distributed computers, and other terms. Computers may facilitate communications between users and/or other computers, may provide data storage systems, may perform analysis and/or transformation of data, and/or perform other functions. It will be understood by those of ordinary skill that those terms used herein may be interchangeable for some embodiments.

Computers may be linked to one another via a network or networks. A network may be any plurality of completely or partially interconnected computers wherein some or all of the computers are able to communicate with one another. It will be understood by those of ordinary skill that connections between computers may be wired in some cases (e.g., via Ethernet, coaxial, optical, or other wired connection) or may be wireless (e.g., via Wi-Fi, WiMax, 4G, or other wireless connections). Connections between computers may use any protocols, including connection-oriented protocols such as TCP or connectionless protocols such as UDP. Any connection through which at least two computers may exchange data can be the basis of a network.

A blockchain is a self-referencing data structure which may be extremely tamper resistant. In addition to its tamper resistance, the self-referencing nature of the data structure may also enforce an arrow of time. Everything in block X−1 must have occurred before block X in order for block X to be written, for example. Blockchain tamper resistance may require that alterations to a piece of data stored within that blockchain force all blocks of data recorded between the initial write of said datum and the present moment be altered in order for the blockchain to remain valid. Without such additional alteration, the traversal of the data structure's blocks via their self-referential mechanism may fail, and it may become self-evident that tampering has taken place. This may make it difficult to retroactively alter data stored within a blockchain without that alteration being detected.

In sum, blockchains may be characterized by at least three features. Blockchains may codify discrete datum into sets of data, called blocks. Blockchains may refer to the previously recorded set of data, i.e., the previous block, in a cryptographically secure manner as part of a new block. Blockchains may directly enable the traversal backwards in time across all previously recorded sets of data in order to prove the validity of the data written therein.

Blockchains may be implemented with every block as an individual file on a file system. However, the three features of blockchains described above do not require that every block be stored as a single independent file on a filesystem. A block may be composed of multiple files, the entirety of the blockchain may be written into a single file, etc., and these three characteristics may still be provided. The blockchain data need not reside directly on a file system at all. A block may be written into a data storage system, across multiple data storage systems, or even as a combination of disparate storage types and mediums. Indeed, the data within a block need not be recorded as a sub-structure of the block at all, as long as the data may be codified, accepted, and written as a set; the data within the block cannot be altered without causing a cascading destruction of the blockchain's integrity; and sets of data may be traversed backwards in time.

Thus, a block may contain two distinct types of information, the data intended to be stored in a tamper resistant manner and the metadata providing the tamper resistance. So long as reconstruction can be accomplished without undermining the cryptographic securities in place, these different types of data may be stored in different files on a filesystem, in different data storage system tables, or across any combination of disparate storage types and mediums.

### Blockchain-Enhanced Data Storage Systems

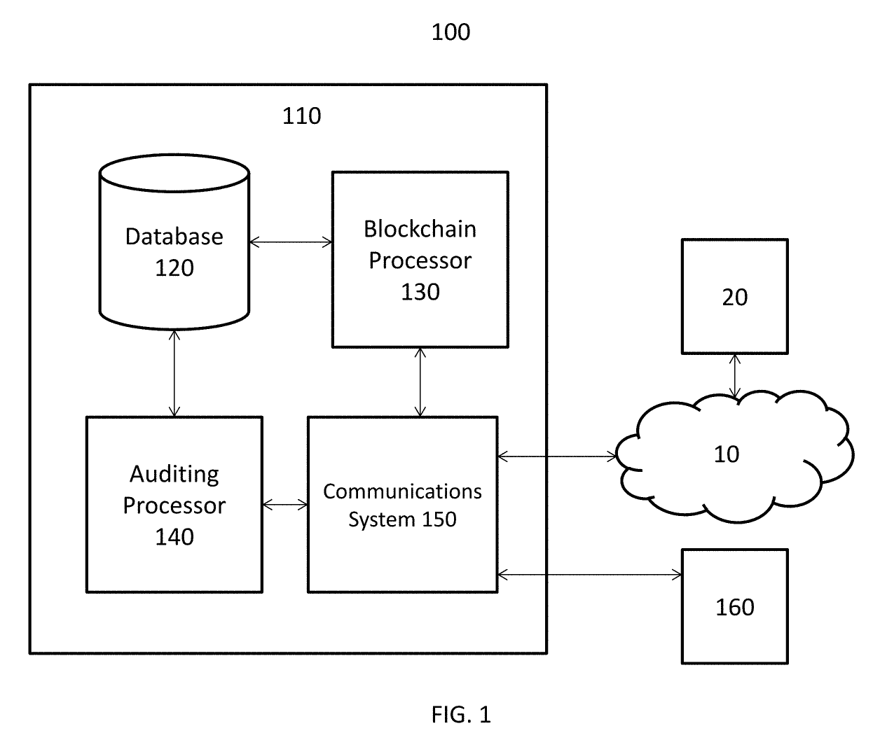

Given these blockchain features, blocks of a blockchain may be stored in a data storage system and used to validate other data stored in the same data storage system. FIG. 1 is a data storage system 100 according to an embodiment of the invention. The data storage system 100 may include one or more data storage servers 110 which may be in communication with one or more local terminals 160 and/or remote computers 20 via a network 10 such as the Internet or an enterprise network, for example. The data storage server 110 may include a database or other data storage system 120 (e.g., an SQL or non-SQL storage system comprising memory, processing elements, and/or other hardware, software, and/or firmware), a blockchain processor 130, an auditing processor 140, and/or a communications system 150 allowing the data storage server 110 to communicate with the local terminals 160 and/or remote computers 20.

One data storage server 110 is shown in FIG. 1, although the components of the server 110 may be distributed among multiple devices in some embodiments, and in other embodiments a plurality of similar servers 110 having some or all of the components may be provided. In some embodiments, the computers used in the described systems and methods may be special purpose computers configured specifically to provide blockchain-enhanced data storage systems and/or to enhance existing data storage systems to include blockchains. For example, a device may be equipped with specialized processors, memory, communication modules, etc. that are configured to perform the functions described herein.

The following implementation example uses a postgres SQL database, although the same principles may apply to other data storage system types. The information in the blocks of the blockchain may be logically split into two tables: a first table including the data to be stored and a second table including the metadata which provides tamper resistance for the stored data. The data to be stored may look and function exactly like any other implementation of data storage in a data storage system. Indeed, blockchain tamper proofing may be applied to any dataset, even retroactively.

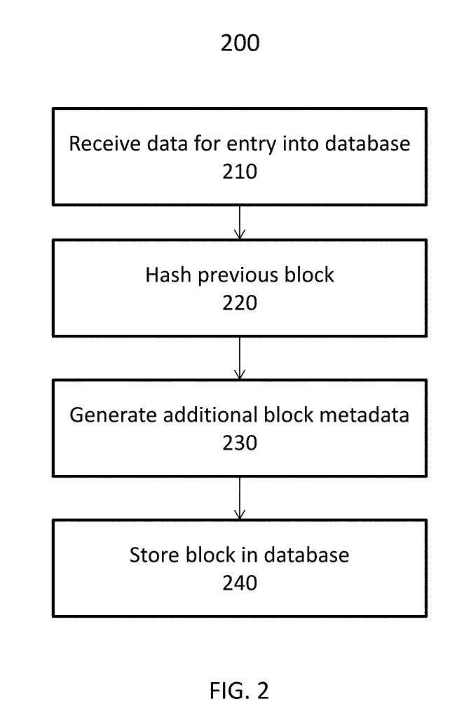

FIG. 2 is a data storage system storage process 200 according to an embodiment of the invention. In 210, the communications system 150 may receive data for entry into the data storage system 120. Alternatively, in situations wherein the blockchain enhancements are being applied to a preexisting set of data in the data storage system 120, in 210 the blockchain processor 130 may retrieve the data from the data storage system 120 itself. The blockchain processor 130 may then generate metadata including blockchain data. The metadata may have a number of additional protections, storage of a cryptographic hash of each datum, for example, but it may contain information about which data compose what block and the value of the cryptographic hash of the previous block.

In 220, the blockchain processor 130 may generate the hash of the previous block. The cryptographic hash of the previous block may be implemented via any secure hashing algorithm, as long as the hashed data includes the hash of the previous block. In order to determine the hash of block X, one may gather all data in that block (1, 2, 3, etc.) alongside the hash value of block X−1 and perform the hashing algorithm against that newly combined data set. This may provide the cryptographic glue of a blockchain implementation. In some embodiments additional data may also be hashed, but this data set may be enough to establish a blockchain hash.

In 230, the blockchain processor 130 may generate any additional block metadata that may be desired. For example, in a simple data storage system implementation, the row address of the data in the previous block may be determined so that it may be stored along with the hash of the previous block. With this information, an auditor may reconstruct the data set necessary to verify the proper chaining of each block via cryptographic hashing as described below.

In 240, the blockchain processor 130 may store the data for entry and the metadata (including the hash of the previous block and the row address of the data in the previous block) in the data storage system 120. In some embodiments wherein the blockchain enhancements are being applied to a preexisting set of data in the data storage system 120, the blockchain processor 130 may overwrite the data previously read from the data storage system 120.

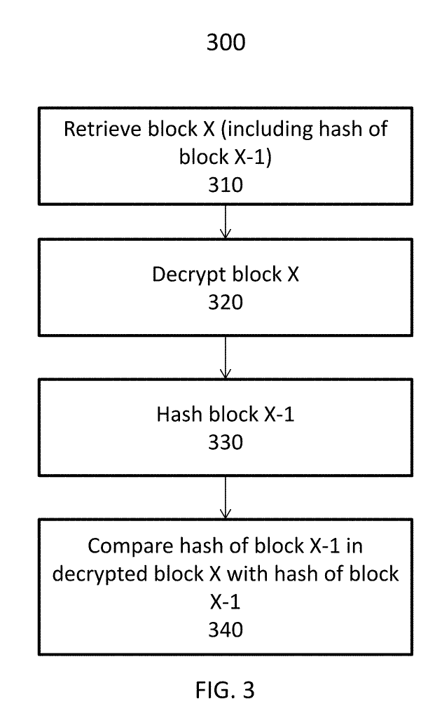

FIG. 3 is a data storage system auditing process 300 according to an embodiment of the invention. The process 300 is presented as performing an audit on a single block (i.e., a single entry in the data storage system 120), but the process 300 may be repeated as necessary to audit a set of blocks or every block in the data storage system 120. To audit a block X−1, in 310 the auditing processor 140 may retrieve block X (including a hash of block X−1) from the data storage system 120. In 320, the auditing processor 140 may decrypt block X using the appropriate algorithm for decrypting information that has been encrypted by the algorithm used to initially encrypt and store the data in the process 200 of FIG. 2. Once the data of block X has been decrypted, in 330 the auditing processor 140 may use the row address of the previous block X−1 from the decrypted data to retrieve block X−1 from the data storage system 120 and hash block X−1. In 340, the auditing processor 140 may compare the hash of block X−1 from the decrypted data to the hash of block X−1 created at 330. If the prior block's hash is present and correct in block X, the data stored in the block X−1 may be verified as representing what was actually initially stored. If there is no hash in block X, or if the hash does not match the hash of block X−1, the auditor may know that the data in block X−1 has been altered after initial storage. Accordingly, any tampering with the data storage system may be easily detected through an audit.

In the previous example, the data from the blockchain is not encrypted independent of any blockchain-level encryption. However, in some embodiments, the data may be independently encrypted. The implementation may work in the same way, with the encrypted data and the hash of the previous block being arranged into a combined data set and hashed according to a process such as that of FIG. 2.

Because the blockchain-enhanced data may be stored in the data storage system like any other implementation of data storage in a data storage system, the full suite of data storage system tools available to data storage system administrators and researchers may be applied to data stored with blockchain enhancements. For example, one may run structured queries against the data. However, note that independently encrypting the data may remove the option to run structured queries against the data in some embodiments.

Another example implementation may use a non-SQL database. Such an implementation may use the processes 200 and 300 of FIGS. 2 and 3 for data storage and auditing, respectively. As with the SQL embodiment, this non-SQL embodiment may leverage the storage technology by separating the data to be stored from the metadata used to provide tamper resistance. Accordingly, the blockchain enhancements may be combined with the scaling and storage features that non-SQL databases provide. For example, map/reduce methods of interacting with the underlying data in non-SQL databases may lend themselves very well to storing the data as independently encrypted blocks. The flexibility in scaling that a non-SQL database provides may ensure that it can be run with sufficient processing power to be able to handle the decryption necessary during such a map/reduce search or during an audit process 300.

### Additional Features

A single blockchain may be used as cryptographic proof of data integrity, but in order to reap that benefit, the entirety of the chain may be made available to read (e.g., by the auditing processor 140). Analysis of the entire chain may provide the proof of integrity. In order to maintain data privacy, many different blockchains may be used by the system 100 to store and verify data that may be accessible by different entities. The system 100 may enable an affiliate to independently verify the integrity of their data. Integrity may be verified against any individual chain as described above. Thus proof of integrity may be completed with no violation of data privacy. For example, a single server 110 may host multiple entities' financial information. Each entity may desire isolation and data privacy from the other entities. Each entity may be provided with an independent chain containing only the information to which it has purview.

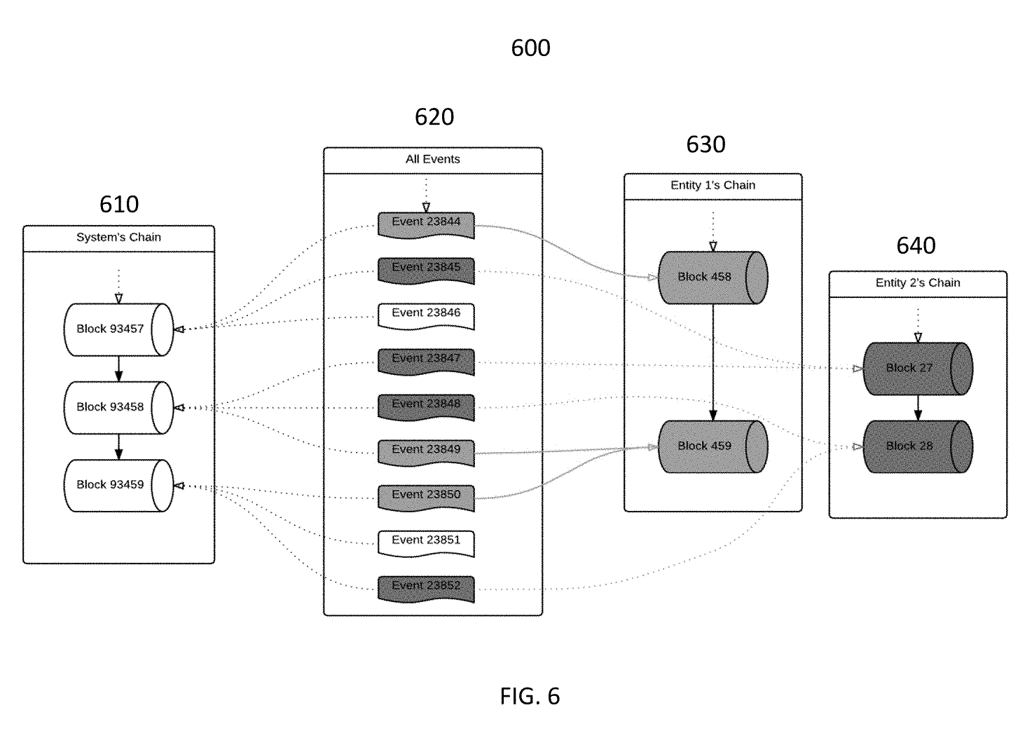

FIG. 6 is a data storage system structure 600 according to an embodiment of the invention. The data storage system 120 as a whole may have a blockchain 610 with a plurality of blocks. Each block may include data regarding a plurality of events 620. Multiple entities may have access to subsets of the events; in this example Entity 1 and Entity 2. Entity 1 may have a blockchain 630, and Entity 2 may have a separate blockchain 640. Each entity's blockchain may include blocks containing event data for the events to which the entity has access, as shown in FIG. 6. Thus, the overall system's integrity may be checked using the system chain 610, and individual entities may audit their own events securely using their own chains 630 and 640, according to the procedures described above. This data structure may provide data integrity and privacy for multiple entities storing data within the same system 100.

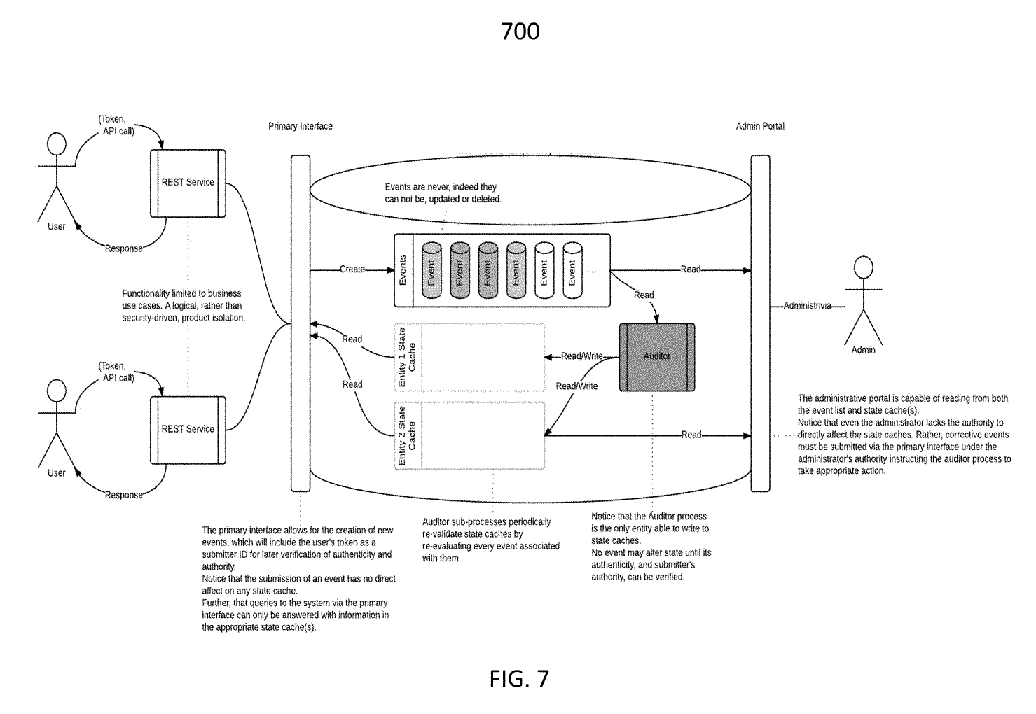

FIG. 7 is a data storage system 700 according to an embodiment of the invention. Some existing data storage systems may be secured using a trusted kernel architecture, which may involve trusting the operating system to control which database management systems (DBMSs) have the authority to modify or query the data storage system and in what way. Other existing data storage systems may abandon this approach in favor of trusting other components, such as the DBMS, directly. The blockchain-enhanced data storage system security model may resemble a trusted kernel architecture, save that it may have fully absorbed and internalized the trusted kernel component. This component, referred to as the auditing processor 140, may be entirely isolated from the outside world, trusting only events which have been fully codified into the blockchain. It may also be the only component authorized to update state tables (e.g., those whose information is returned when the system is queried), as shown in FIG. 7. By internalizing the principles of least privilege with a modified trusted kernel architecture alongside a cryptographically perfect proof of precisely when an event affected the system and what those effects were, the blockchain-enhanced data storage system may offer a black box data store with high levels of integrity and auditability.

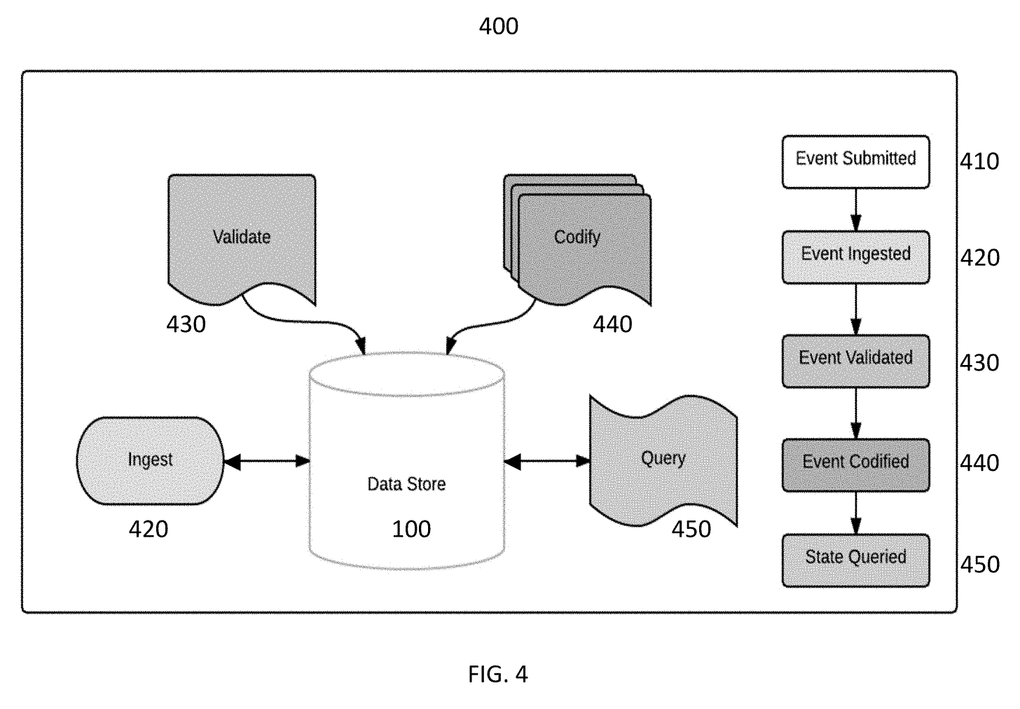

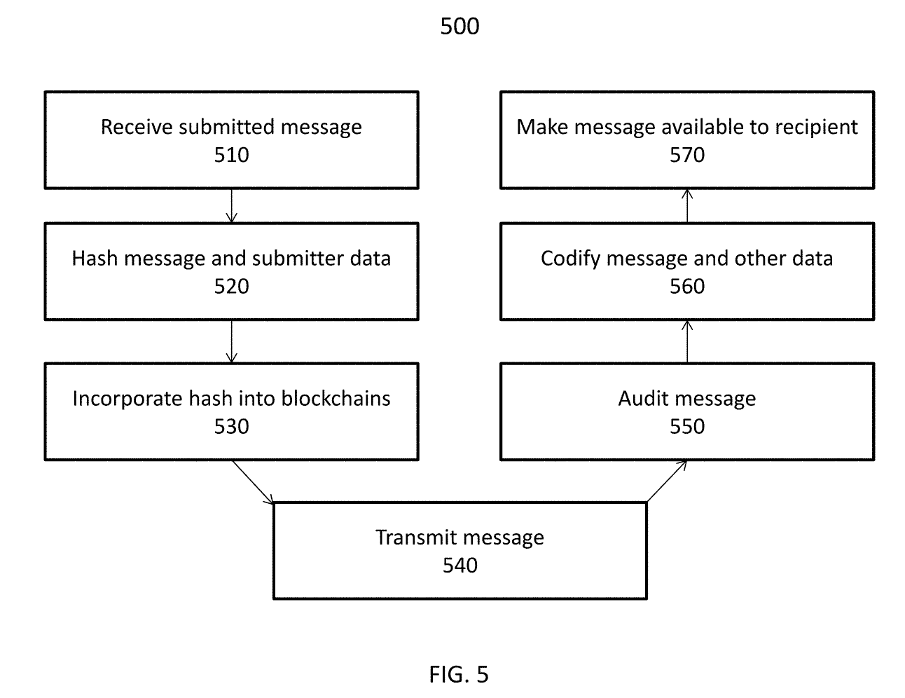

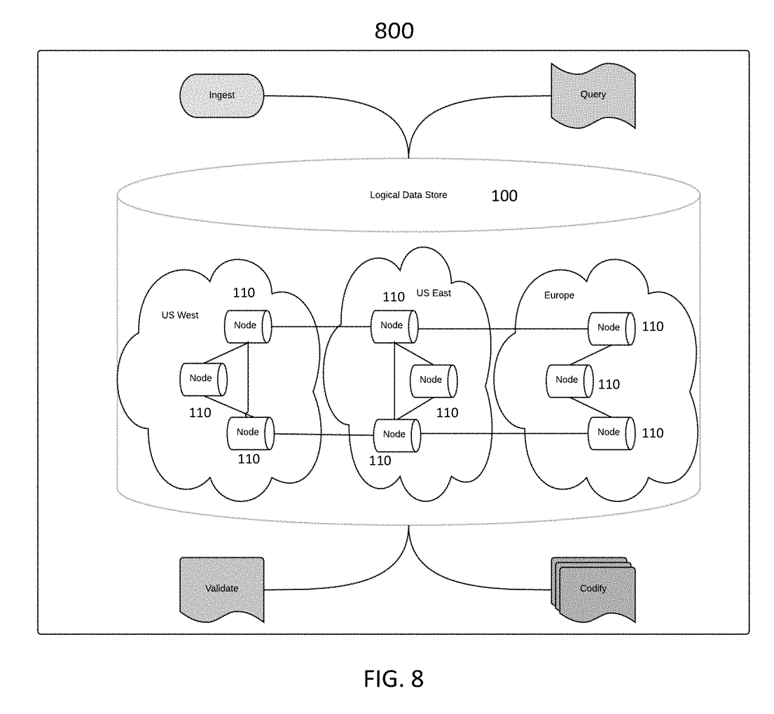

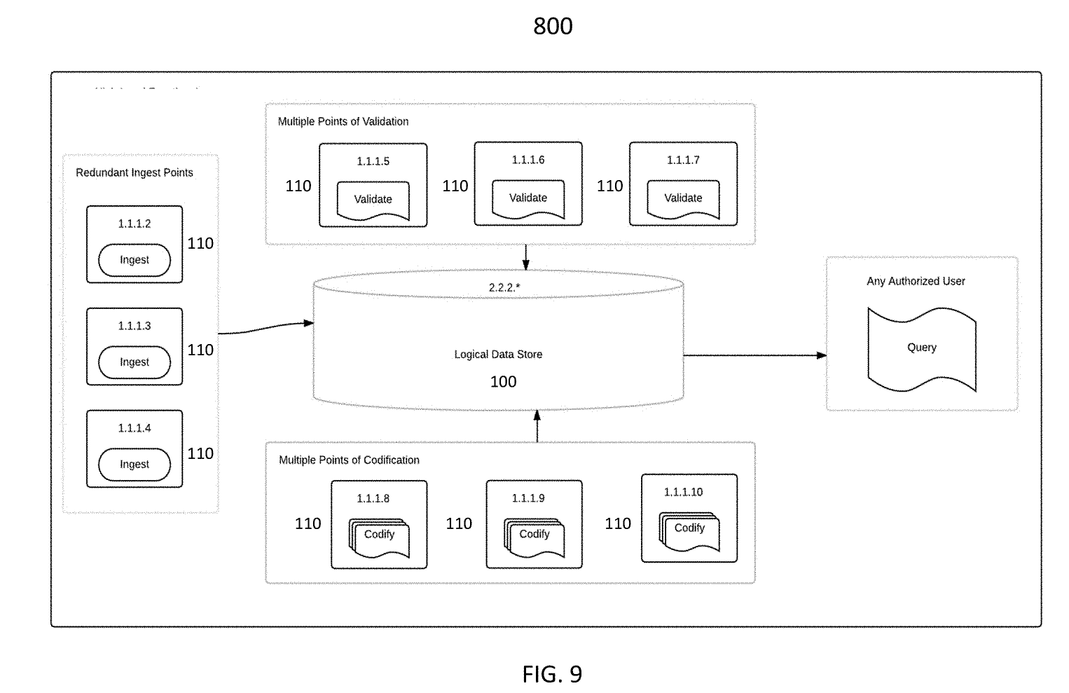

FIGS. 8 and 9 show a data storage network 800 according to an embodiment of the invention. Data integrity can be verified and defended per the above embodiments, but backups may also be used to offer practical data redundancy and availability. Redundant hardware (e.g., servers 110) may be distributed throughout the network 800 and the data and blockchains may be stored at multiple nodes. Furthermore, as shown in FIG. 9, different servers 110 may perform different tasks (e.g., ingest, validation, codification) described above for the same data in the same logical data store 100. In some embodiments, the data and blockchains may be distributed among a plurality of nodes 110 forming a single logical data store 100. The data and blockchain distribution may be random or pseudorandom. The actual location of any individual block or data entry may be unknown to external systems accessing the logical data store 100 (e.g., for data submission or extraction as described below with respect to FIGS. 4 and 5). Distribution of data and blockchains may enhance security, because no one node 110 may have an entire blockchain, and thus access to one node may not allow an attacker to view the entire blockchain.

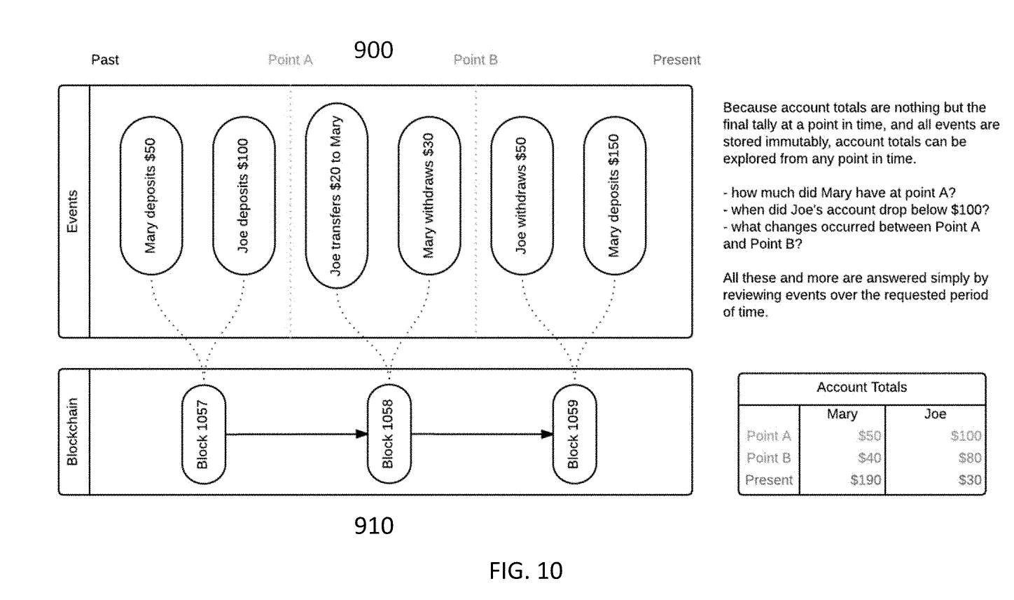

Blockchain technology may provide an immutable chain of events. To answer a question about a present state (where is the ball, what do I owe on my credit card, how long until my next free phone upgrade?) for data stored in a blockchain, all past events may be applied to the original state. To reduce computations required to answer a state question, the system 100 may maintain a cache of what the current state is. FIG. 10 is a state cache 900 according to an embodiment of the invention. The cache containing information about Joe's account, for example, may be updated every time an event which affects that state enters the blockchain 910. So, if Mary sent Joe $50, the cache may be updated to reflect Joe now has +$50 in his account, and Mary −$50. In order that the cache remain just a cache, rather than the ledger itself, auditor processes may continually parse through the entirety of the blockchain (e.g., as described above) and re-verify that the cache accurately represents the current state of affairs.

This feature may also provide a process by which state may be queried from the perspective of any point in the past. Answers to what Joe's account looked like 10 years ago, how it changed between 7 and 3 years ago, or any other question whose answer pivots on time may be answered by re-calculating the state up to the appropriate point in time.

### Blockchain-Enhanced Communications

One example use case for blockchain-enhanced data storage may be within a communications network. FIG. 4 is a communications network data flow 400 according to an embodiment of the invention. A sending party may securely log into the network and submit a message in 410 via a sending party device (e.g., a computer, smartphone, tablet, etc.). The message may be ingested to a secured central storage in 420 (e.g., data storage system 100) where it may be validated in 430, codified in 440, and stored until such time as the intended recipient(s) log into the system and request messages addressed to them via a receiving party device in 450 (e.g., a computer, smartphone, tablet, etc.). The appropriate messages may be transmitted to their recipients and either archived or removed from the central storage system.

FIG. 5 is a message storage and transmission process 500 according to an embodiment of the invention. This process 500 may be a specific example of a process driving the network data flow 400 of FIG. 4, for example. In 510, the sending party may securely log into the network and submit a message. The message may not be immediately transmitted. Instead, in 520, the communications system 150 may receive the message, and a hash of the message and submitter information may be generated by the blockchain processor 130. In 530, the blockchain processor 130 may incorporate that hash into several immutable blockchains within the data storage system 120, and then in 540 the message itself may be transmitted to other data storage systems 100 by the communications system 150. A distributed system comprising multiple data storage systems 100 in communication with one another via the network 10 may create multiple copies of the message across a large subset of participating nodes in some embodiments. Which specific nodes store physical copies of the message may be unknown and uncontrolled by the sender. As it is distributed, the message itself may also be incorporated into several immutable blockchains.

Once entered into the system, in 550, multiple auditing processors 140 may review the message and independently attest to its validity. Each attestation may be incorporated into several immutable blockchains. Once validity has been proven, in 560, the full validations of the message, along with the message, the submitter information, and the references to the appropriate, previously created, blocks storing the above may be codified into several immutable blockchains by blockchain processors 130 at one or more nodes.

Fully codified, the message, along with independent references to all involved blockchains, may be made available for query by the intended recipient(s) after they have securely logged into the system in 570. Final delivery of the message by the communications system 150 to the recipient may hinge on final verification of all presented auditing information regarding the message's validity. The system may retain all messages and related audit trails.

Through this process 500, the message may be securely ingested and hashed prior to being incorporated into a blockchain, and then the blockchain may be distributed among a plurality of nodes. These features may allow the system to safeguard message validity against several avenues of attack. For convenience, different avenues of attack may be categorized as means to achieving certain goals herein. There may be other goals and potentially other methods an adversary may use to achieve these goals. Rather than attempt an exhaustive explanation of all such prospective methods and their associated defensive functionality, these examples address major concerns as well as offer insight into the overarching philosophy and effectiveness of the blockchain-enhanced security measures.

### Goal: The Execution of an Unauthorized Message

### Method: Interception and Injection

Here, the adversary uses their position in the system to intercept the recipient's request for valid messages, instead responding with their own unauthorized message. In a centralized system, where encryption has been fully compromised, an adversary may need only control any component of the network between the recipient and the central system, or the central system itself, in order to effectively perpetrate this attack.

With the blockchain-enchanced system, as it is a fully distributed system, an attacker will not know which node of the platform the recipient will query. Indeed, by default several nodes may be queried, and the results may be compared. This may complicate what specifically needs to be compromised in order to effectively intercept the recipient's request. More than simply complicating the details of initial compromise, blockchain enhancement may force the adversary to manage a synchronized, distributed system of their own in order to consistently respond to such requests.

As discussed above, a blockchain may be distributed among several nodes 110 in a logical data store 100. Because the data may distributed throughout the node 110 cluster in pseudo-random fashion, both as it propagates to other nodes 110 for auditing (see 540 and 550 of FIG. 5) and is distributed to other nodes 110 for data backup, a query for that data may be made against several different nodes 110 to verify that it has been accurately written at least somewhere, that it has been sufficiently backed up (written accurately to multiple nodes 110), and/or that the data returned by any given node 110 matches that returned by any other given node 110. By default, queries against this system may seek what is referred to as a local quorum before reporting any data, meaning the nodes 110 in the physical data center must all have the same copy of the data before it will be reported to a client as fact. For a discussion of local quorum reporting in blockchains, see U.S. Provisional Patent Application 62/244,376, entitled “Event Synchronization Systems and Methods,” the entirety of which is incorporated by reference herein.

An attacker attempting to compromise the system in an effort to respond with inaccurate data may need to compromise each of the system's nodes 110 such that they would all lie about the data faithfully. The adversary may then need to orchestrate the appropriate responses to a flurry of auditing requests. The full trail of the message through the system may be reviewed before the message is delivered to the recipient. The compromising agent on each of the local nodes 110 would need to correctly field all types of queries about the data, its metadata, and associated blockchain(s). A sampling of the types of queries which may need to be fielded accurately include the submitter's ID, the hash of the pre-validated message submitted before the message entered the system, the appropriate blockchain references and the blocks of those chains necessary to support the hash's validity, each validator's stamp of approval along with every appropriate blockchain reference and supporting blocks for such, the codifier's ID, and/or subsequent final blocks containing the approved, fully validated, message.

### Method: Fraudulent Injection

Here the adversary uses their compromise of the system's cryptographic keys to spoof the identity of the appropriate sender, craft their desired message, and submit it normally to the system.

Starting even before message submission, the blockchain-enchanced system may defend against this type of attack. Pre-submission of the hash of the appropriately non-validated initial message may ensure that the attempt will be recorded even before it has truly begun. Upon successful submission, the adversary may then find it necessary to have previously compromised every authenticator in the system, each using a different algorithm for validation checking, so that they may be leveraged to continue forging the fraudulent message. Finally, the adversary may be required to compromise each codifier in order for the final checks to succeed and the fraudulent message to be written into the appropriate blockchains as legitimate.

As discussed above, a transmission may be hashed before it is codified into a blockchain. See 520 and 530 of FIG. 5. By forcing the cryptographic hash of a transmission to be codified into the blockchain before the actual transmission is sent, the system may force an attacker to attempt to compromise two disparate, but related, points in time on the blockchain, block X with the hash of the transmission and block X+1 with the actual transmission.

Submission of the transmission may hinge on verification of the successful codification of its hash. Thus the client may query the system to this end. As outlined above, the attacker will need to have compromised the local nodes 110 in order to faithfully report that the hash of the original message has been codified even though it has not. In so doing, the attacker will have lied about the contents of block X−1, as it has no such hash written to it. Having verified, to the best of its ability, codification of the hash of its transmission, the client will then submit the transmission itself and attempt to verify its accurate codification. The attacker may need to stall the client's queries as the to-be-injected transmission needs to first have its hash and then itself codified into blocks. The client may now query to verify that block X−1 has a hash of the transmission it expects to see in block X. The attacker will need to intercept and falsify those queries, along all local nodes, by generating block X by hand and synchronizing its contents out of band with the other compromised local nodes. In sum, accepting the hash of the transmission before the transmission and keeping both facts codified in the blockchain makes this attack extremely difficult.

### Method: Direct Data Insertion

Here the adversary uses their compromise of the system's cryptographic keys, as well as their compromise of the platform, to insert data directly into the system's storage mechanism. Low level data storage system access or direct file system access may be employed. Our assumption of full compromise makes low level data storage system access equally effective, and significantly easier, than direct file system access, so low level data storage system access is assumed in this example. The adversary executes a simple function call to insert the data and does some quick log editing to hide his tracks.

Direct access to the data storage system in the blockchain-enhanced system may be deceptively tantalizing. It may seem that one should be able to execute all of the data compromises outlined above from a single vantage point. However, actually doing so may require prohibitively complex timing attacks. After pushing the pre-submission hash of the message, and then the message itself, the attacker may be forced to fight against the distribution mechanisms of the system. It may be impossible for the attacker to know at any given moment the specific view in time of any other component of the system. Knowing whether any given validator has picked up and attempted to verify the just-inserted message, for example, may be impossible until such time as the validator has done so and its effects have been propagated back to the attacker's node(s). In that time, other validators, and multiple codifiers, may or may not have acted on the message and related metadata.

In the previous examples, the attacker will only need lie to a client when the client performs queries on behalf of the user for data integrity. In this example, the attacker will need to coordinate a distributed system of lies to accurately respond to each subcomponent of the system as the falsified data makes its way through the system. This is due to the pseudo-random distribution of data and the pseudo-random subcomponent execution necessary to support such (see FIGS. 8 and 9). It may be unknown precisely when any given data integrity check (e.g., validation, codification, or auditing) will be conducted, and that timing may vary from node to node, second to second. As long as the data isn't changed during the process, integrity checks may work regardless of when they are performed. If the data is altered somewhere (e.g., by an intruder), everything comes crashing down.

The attacker may need to successfully write over a validator's rejection after the validator has written it but before a codifier has recorded the rejection into a blockchain. Writing before the validator has written may make it possible that the codifier will have picked up the fraudulent write into a blockchain such that the information the validator then writes may indicate an attack just the same as had the attacker missed the window themselves. Because there may be multiple validators and codifiers all operating at different rates and for different purposes, even accurately mapping the windows of time necessary to perpetrate this attack would be a phenomenal achievement itself, easily as difficult as the other attack vectors.

### Goal: The Removal or Alteration of a Message

### Method: Message Interception

Here the attacker uses their compromise of the system's cryptographic keys and access to the system to intercept and alter, or erase, a message from an otherwise authorized sender.

The blockchain-enhanced system may present a challenge to an attacker in this scenario as the sender first shares a hash of the yet unsent message. Without verification of this hash's prior receipt and codification into a blockchain, the sender may not release the message. Once that hash has been written, the attacker may be forced to perform a hash collision attack in order to alter the message without being detected. As discussed with respect to unauthorized message execution, the system's distributed blockchain may safeguard against such attacks.

Rejecting that strategy, the attacker may instead hold the original hash and intercept all of the sender's queries about the hash having been successfully written in order to lie and convince the sender to transmit the actual message, at which point the attacker may have the flexibility to insert a custom message (as discussed above) or erase it entirely. Either way, they may need to continue to lie to the sender as it tracks the imaginary progress of the original, never delivered, message through the validation and codification process.

### Method: Direct Data Insertion

Here the adversary leverages their compromise of the system's cryptographic keys and system access to write directly to the data store in an effort to modify or destroy a message in transit. This may proceed exactly as the direct insertion of a new message aside from the function calls one would make.

The blockchain-enhanced system may be able to prevent such attacks before they even begin. The pre-submission of a message's hash before submission of the message may mean the hash may be codified into several different blockchains as it becomes simultaneously visible to both the adversary and the codification processes. Dynamically re-writing multiple blockchain simultaneously without being overwhelmed by one of the codifiers is the cost of altering that hash for an attacker. As discussed with respect to unauthorized message execution, hashing a message before inserting it into a blockchain may safeguard against such attacks.

Even assuming such an alteration were successful, the sender itself may trip a set of alarms by submitting a message referencing a hash that no longer matches. The sender may recover, record the incident, and attempt to re-submit. This may begin the race anew.

Attempting to alter the message after the sender has finished submitting it may require the simultaneous re-writing of the blockchains involved in both the pre-message hash record and the original method record in spite of the ongoing codification processes. Should that be successful, the verifiers' and codifiers' additions to the record must also be accounted for. Essentially, the complexity of such an attack will quickly overwhelm an attacker.

### Retrofitting Populated Data Storage Systems With Blockchain Enhancements

Blockchain features, such as those described above, may be added to existing data storage systems that are already populated with one or more data entries. Even when data entries are already stored in a data storage system without blockchain enhancements, one or more of the following techniques may be used to retroactively apply the blockchain enhancements to the stored data entries. Specific approaches may be selected to balance the additional security provided by blockchain enhancements against the invasiveness of the blockchain enabling mechanism. The approaches may be data store agnostic, working for existing SQL, non-SQL, flat file, and any other storage strategy available. In these approaches, system 100 may be retrofitted onto a preexisting data storage system 120, for example.

### Logs

Data stores may be configured to log any and all use or alteration of the data stored therein. By accepting these logs as they are generated and codifying them into a blockchain, an immutable, auditable record of those events may be created. Thus, the data storage system is now blockchain enabled. This may provide a noninvasive mechanism for retrofitting a live data storage system.

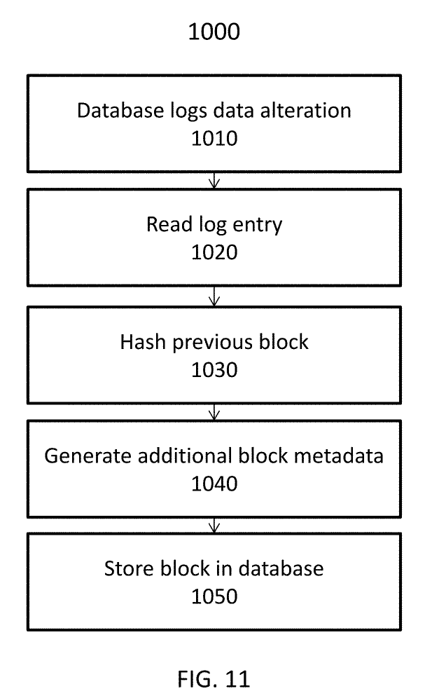

FIG. 11 is a data storage system logging process 1000 according to an embodiment of the invention. In 1010, the preexisting data storage system 120 may log a data alteration. In 1020, the blockchain processor 130 may read the new log entry.

In 1030, the blockchain processor 130 may generate the hash of the previous block. The cryptographic hash of the previous block may be implemented via any secure hashing algorithm, as long as the hashed data includes the hash of the previous block. In order to determine the hash of block X, one may gather all data in that block (1, 2, 3, etc.) alongside the hash value of block X−1 and perform the hashing algorithm against that newly combined data set. This may provide the cryptographic glue of a blockchain implementation. In some embodiments additional data may also be hashed, but this data set may be enough to establish a blockchain hash.

In 1040, the blockchain processor 130 may generate any additional block metadata that may be desired. For example, in a simple data storage system implementation, the row address of the data in the previous block may be determined so that it may be stored along with the hash of the previous block. With this information, an auditor may reconstruct the data set necessary to verify the proper chaining of each block via cryptographic hashing as described below.

In 1050, the blockchain processor 130 may store the data from the log and the metadata (including the hash of the previous block and the row address of the data in the previous block) in the data storage system 120.

### Query Mirroring

Data storage systems may be interacted with using a query mechanism of some kind. By creating two copies of every query, one copy may be used for interaction with the data storage system, and the other may be used to codify into a blockchain any and all queries to the data storage system. This may create an immutable, auditable record of those events. Thus, the data storage system is now blockchain enabled. This may be a slightly more invasive mechanism for blockchain retrofitting than the logging mechanism (because query data may be captured and written into the blockchain), but may offer the security benefits of codifying logs along with the ability to codify interactions which do not produce logs.

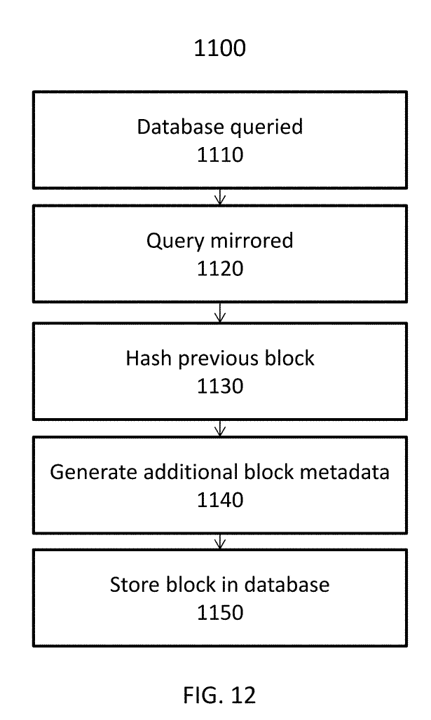

FIG. 12 is a query mirroring process 1100 according to an embodiment of the invention. In 1110, the preexisting data storage system 120 may be queried. In 1120, the blockchain processor 130 may create a copy of the query for insertion into a blockchain.

In 1130, the blockchain processor 130 may generate the hash of the previous block. The cryptographic hash of the previous block may be implemented via any secure hashing algorithm, as long as the hashed data includes the hash of the previous block. In order to determine the hash of block X, one may gather all data in that block (1, 2, 3, etc.) alongside the hash value of block X−1 and perform the hashing algorithm against that newly combined data set. This may provide the cryptographic glue of a blockchain implementation. In some embodiments additional data may also be hashed, but this data set may be enough to establish a blockchain hash.

In 1140, the blockchain processor 130 may generate any additional block metadata that may be desired. For example, in a simple data storage system implementation, the row address of the data in the previous block may be determined so that it may be stored along with the hash of the previous block. With this information, an auditor may reconstruct the data set necessary to verify the proper chaining of each block via cryptographic hashing as described below.

In 1150, the blockchain processor 130 may store the mirrored query and the metadata (including the hash of the previous block and the row address of the data in the previous block) in the data storage system 120.

### Network Logging

Similar to query mirroring, this mechanism may codify, into a blockchain, a copy of every network packet into and out of the data storage system. This may create an immutable, auditable record of those packets. Thus, the data storage system is now blockchain enabled. This mechanism may be somewhat less invasive than query monitoring in terms of the mechanics of retrofitting current systems. However, unless the logging mechanism is configured only to capture packets containing queries (e.g., after examining the packets), it may capture all traffic, to include administrative non-query based traffic, into an immutable record. The potential sensitivity of the data captured into this immutable record may make the overall result slightly more invasive than query mirroring. This technique may, however, offer an immutable record of all network-based interactions with the data store whether related to the state data stored therein or not.

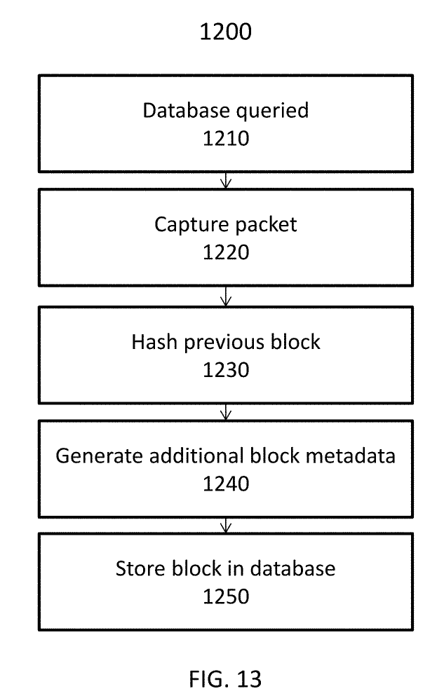

FIG. 13 is a network logging process 1200 according to an embodiment of the invention. In 1210, the preexisting data storage system 120 may be queried via a network connection (e.g., the query may be received via communications system 150 from a remote computer through network 10) and/or any other packet may be sent and/or received to and/or from the data storage system 120 via the communications system 150. In 1220, the blockchain processor 130 may capture a copy of the packet for insertion into a blockchain.

In 1230, the blockchain processor 130 may generate the hash of the previous block. The cryptographic hash of the previous block may be implemented via any secure hashing algorithm, as long as the hashed data includes the hash of the previous block. In order to determine the hash of block X, one may gather all data in that block (1, 2, 3, etc.) alongside the hash value of block

X−1 and perform the hashing algorithm against that newly combined data set. This may provide the cryptographic glue of a blockchain implementation. In some embodiments additional data may also be hashed, but this data set may be enough to establish a blockchain hash.

In 1240, the blockchain processor 130 may generate any additional block metadata that may be desired. For example, in a simple data storage system implementation, the row address of the data in the previous block may be determined so that it may be stored along with the hash of the previous block. With this information, an auditor may reconstruct the data set necessary to verify the proper chaining of each block via cryptographic hashing as described below.

In 1250, the blockchain processor 130 may store the captured packet and the metadata (including the hash of the previous block and the row address of the data in the previous block) in the data storage system 120.

### Query Interception

This technique may focus on queries which are to be executed against the data storage system. Rather than simply receive a copy, however, all queries may be passed directly through an interception module for codification into a blockchain before they are passed to the underlying data storage system and their results returned to the original requestor. This may create an immutable, auditable record of those events. Thus, the data storage system is now blockchain enabled. This may be an invasive mechanism for retrofitting a live data storage system, as may introduce a single point of failure into the system at large (the mechanism itself). The tradeoff for this invasiveness may be that, in addition to the immutable record of a blockchain, query interception may enable additional features of blockchain technology (e.g., as described above) to be retrofitted to the system as well.

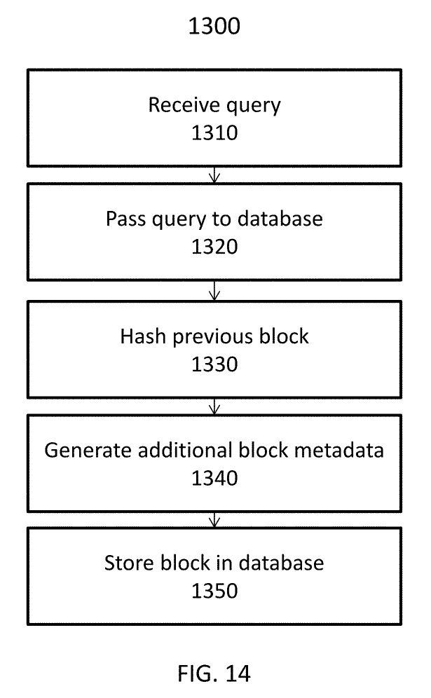

FIG. 14 is a query interception process 1300 according to an embodiment of the invention. In 1310, the blockchain processor may receive a query for the preexisting data storage system 120. For example, the query may be received via communications system 150 from a remote computer through network 10 or in some other manner. In 1320, the blockchain processor 130 may copy the query for insertion into a blockchain and forward the query to the data storage system 120.

In 1330, the blockchain processor 130 may generate the hash of the previous block. The cryptographic hash of the previous block may be implemented via any secure hashing algorithm, as long as the hashed data includes the hash of the previous block. In order to determine the hash of block X, one may gather all data in that block (1, 2, 3, etc.) alongside the hash value of block X−1 and perform the hashing algorithm against that newly combined data set. This may provide the cryptographic glue of a blockchain implementation. In some embodiments additional data may also be hashed, but this data set may be enough to establish a blockchain hash.

In 1340, the blockchain processor 130 may generate any additional block metadata that may be desired. For example, in a simple data storage system implementation, the row address of the data in the previous block may be determined so that it may be stored along with the hash of the previous block. With this information, an auditor may reconstruct the data set necessary to verify the proper chaining of each block via cryptographic hashing as described below.

In 1350, the blockchain processor 130 may store the query data and the metadata (including the hash of the previous block and the row address of the data in the previous block) in the data storage system 120.

While various embodiments have been described above, it should be understood that they have been presented by way of example and not limitation. It will be apparent to persons skilled in the relevant arts that various changes in form and detail can be made therein without departing from the spirit and scope. In fact, after reading the above description, it will be apparent to one skilled in the relevant arts how to implement alternative embodiments. For example, various applications of the systems and methods described herein may include exchange of financial information; managing rewards points; storing and exchanging transaction-specific payment tokens; facilitating remittance services; reconciling accounts across disparate entities (e.g., subsidiaries and/or partners); consolidating discrete business unit or private ledgers; replacing legacy core settlement systems; transferring health care information; and/or other applications.

In addition, it should be understood that any figures that highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims, and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A system for modifying a populated data storage system, comprising:
a blockchain processor configured to:
receive data associated with an interaction with the populated data storage system;
hash a first previously entered data block at a first row address;
combine the received data, the hash of the first previously entered data block, and the first row address into a data block; and
store the data block.

2. The system of claim 1, wherein the data associated with the interaction with the populated data storage system comprises a data storage system log entry.

3. The system of claim 1, wherein the blockchain processor is configured to receive the data associated with the interaction with the populated data storage system by reading the data from a data storage system log.

4. The system of claim 1, wherein the data associated with the interaction with the populated data storage system comprises a query against the populated data storage system.

5. The system of claim 1, wherein the blockchain processor is configured to receive the data associated with the interaction with the populated data storage system by mirroring a query against the populated data storage system.

6. The system of claim 1, further comprising a communications system coupled to the blockchain processor and configured to:
receive the data associated with the interaction with the populated data storage system from a computer; and
send the received data to the blockchain processor.

7. The system of claim 6, wherein the communications system is configured to receive the data associated with the interaction with the populated data storage system by capturing a packet sent to or from the populated data storage system.

8. The system of claim 6, wherein the communications system is configured to receive the data associated with the interaction with the populated data storage system by receiving a query against the populated data storage system.

9. The system of claim 8, wherein the communications system is further configured to forward the query to the populated data storage system.

10. The system of claim 1, wherein:
the blockchain processor is further configured to encrypt the received data; and
the received data in the data block comprises the encrypted received data.

11. The system of claim 1, further comprising an auditing processor configured to:
retrieve the data block;
decrypt the data block to form decrypted data;
identify a second row address in the decrypted data;
retrieve a hash of a second previously entered data block stored at the second row address; and
compare the hash of the second previously entered data block to a hash in the decrypted data.

12. The system of claim 11, wherein the auditing processor is further configured to determine that the decrypted data has not been tampered with when the hash of the second previously entered data block matches the hash in the decrypted data.

13. The system of claim 11, wherein the auditing processor is further configured to determine that the decrypted data has been tampered with when the hash of the second previously entered data block does not match the hash in the decrypted data.

14. The system of claim 11, wherein the auditing processor is further configured to:
codify the data block into a message; and
make the message available to a recipient.

15. The system of claim 1, further comprising the populated data storage system.

16. A method for modifying a populated data storage system, comprising:
receiving, with a blockchain processor, data associated with an interaction with the populated data storage system;
hashing, with the blockchain processor, a first previously entered data block at a first row address;
combining, with the blockchain processor, the received data, the hash of the first previously entered data block, and the first row address into a data block; and
storing, with the blockchain processor, the data block.

17. The method of claim 16, wherein the data associated with the interaction with the populated data storage system comprises a data storage system log entry.

18. The method of claim 16, wherein receiving, with the blockchain processor, the data associated with the interaction with the populated data storage system by reading the data from a data storage system log.

19. The method of claim 16, wherein the data associated with the interaction with the populated data storage system comprises a query against the populated data storage system.

20. The method of claim 16, wherein receiving, with the blockchain processor, the data associated with the interaction with the populated data storage system by mirroring a query against the populated data storage system.

21. The method of claim 16, further comprising:
receiving, with a communications system coupled to the blockchain processor, the data associated with the interaction with the populated data storage system from a computer; and
sending, with the communications system, the received data to the blockchain processor.

22. The method of claim 21, wherein receiving, with the communications system, the data associated with the interaction with the populated data storage system comprises capturing a packet sent to or from the populated data storage system.

23. The method of claim 21, wherein receiving, with the communications system, the data associated with the interaction with the populated data storage system comprises receiving a query against the populated data storage system.

24. The method of claim 23, further comprising forwarding, with the communications system, the query to the populated data storage system.

25. The method of claim 16, further comprising encrypting, with the blockchain processor, the received data, wherein the received data in the data block comprises the encrypted received data.

26. The method of claim 16, further comprising:
retrieving, with an auditing processor, the data block;
decrypting, with the auditing processor, the data block to form decrypted data;
identifying, with the auditing processor, a second row address in the decrypted data;
retrieving, with the auditing processor, a hash of a second previously entered data block stored at the second row address; and
comparing, with the auditing processor, the hash of the second previously entered data block to a hash in the decrypted data.

27. The method of claim 26, further comprising determining, with the auditing processor, that the decrypted data has not been tampered with when the hash of the second previously entered data block matches the hash in the decrypted data.

28. The method of claim 26, further comprising determining, with the auditing processor, that the decrypted data has been tampered with when the hash of the second previously entered data block does not match the hash in the decrypted data.

29. The method of claim 26, further comprising:
codifying, with the auditing processor, the data block into a message; and
making, with the auditing processor, the message available to a recipient.

30. The method of claim 16, further comprising coupling the blockchain processor to the populated data storage system.
